(19) United States
(12) Patent Application Publication
(10) Pub. No.: US 2006/0236149 A1
(43) Pub. Date: Oct. 19, 2006

(54) System and method for rebuilding a storage disk

(75) Inventors: Nam Nguyen, Round Rock, TX (US); Jacob Cherian, Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/106,401

(22) Filed: Apr. 14, 2005

(51) Int. Cl. G06F 11/00

(52) U.S. Cl. 714/6

(57) ABSTRACT

A system and method for rebuilding a storage drive utilizes a rebuild management module within a RAID controller to conduct a substantially sequential rebuild operation on a rebuild disk. When the rebuild management module receives host I/O requests during a rebuild operation, these requests are facilitated using other disks. After the substantially sequential rebuild is complete, the rebuild management module updates the rebuild disk based upon the host I/O requests received during the sequential rebuild operation.

### TECHNICAL FIELD

The present invention is related to the field of computer systems and more specifically to a system and method for rebuilding a storage disk.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

To provide the data storage demanded by many modern organizations, information technology managers and network administrators often turn to one or more forms of RAID (redundant arrays of inexpensive/independent disks). Typically, the disk drive arrays of a RAID are governed by a RAID controller and associated software. In one aspect, a RAID may provide enhanced input/output (I/O) performance and reliability through the distribution and/or repetition of data across a logical grouping of disk drives.

RAID may be implemented at various levels, with each level employing different redundancy/data-storage schemes. RAID 1 implements disk mirroring, in which a first disk holds stored data, and a second disk holds an exact copy of the data stored on the first disk. If either disk fails, no data is lost because the data on the remaining disk is still available.

In RAID 3, data is striped across multiple disks. In a four-disk RAID 3 system, for example, three drives are used to store data and one drive is used to store parity bits that can be used to reconstruct any one of the three data drives. In such systems, a first chunk of data is stored on the first data drive, a second chunk of data is stored on the second data drive, and a third chunk of data is stored on the third data drive. An Exclusive OR (XOR) operation is performed on data stored on the three data drives, and the results of the XOR are stored on a parity drive. If any of the data drives, or the parity drive itself, fails the information stored on the remaining drives can be used to recover the data on the failed drive.

In most situations, regardless of the level of RAID employed, RAID is used to protect the data in case of a disk failure. Most RAID types can tolerate only a single disk failure. Such a RAID becomes vulnerable after the first disk failure and needs to be rebuilt as fast as possible. However, with disk capacity out-pacing media access speed, the time required for rebuild operations is increasing and may take a significant period of time to complete a rebuild operation while the RAID is simultaneously receiving host I/O requests.

The write performance of the drive being rebuilt often presents a significant bottleneck in the rebuild process. A major factor for slowing down the write performance is that the rebuild occurs at the same time the system is serving clients, and may perform host I/O requests during the rebuild operation. These host I/Os cause the disk head of the drive being rebuilt to move back and forth (sometimes referred to as “disk head thrashing”) in order to move to the necessary disk sectors. Such disk head thrashing substantially increases the rebuild time. In some embodiments this problem is agitated with Serial Advanced Technology Attachment (SATA) drives whose seek time is substantially longer than Small Computer System Interface (SCSI) drives.

### SUMMARY OF THE INVENTION

Therefore a need has arisen for a system and method for reducing the rebuild time of RAID drives.

The present disclosure describes a system and method for utilizing a rebuild management module within a RAID controller for implementing a substantially sequential rebuild operation on the rebuild disk. When the rebuild management module receives host I/O requests during a rebuild operation, these requests are facilitated using other disks within the RAID. After rebuild is complete, the rebuild management module then acts to update the rebuild disk based upon the host I/O requests received during the rebuild operation.

In one aspect, the present disclosure includes an information handling system that includes a redundant array of independent disks (RAID) controller able to communicate with a host and a plurality of storage disks. The RAID controller also includes a rebuild management module able to initiate a rebuild operation utilizing a substantially sequential rebuild operation on the rebuild disk, receive at least one host I/O request from the host, and direct the at least one host I/O request to a disk within the plurality of storage disks other than the rebuild disk.

In another aspect, a method is disclosed that includes providing a RAID controller able to communicate with a host and a plurality of storage disks. The method further includes initiating a rebuild operation on a rebuild disk utilizing a substantially sequential rebuild operation on the rebuild disk. The method also includes receiving at least one host I/O request from the host and directing the at least one host I/O request to a temp disk within the plurality of storage disks.

In yet another aspect, an information handling system is disclosed that includes a host and multiple storage disks including at least one source disk, at least one temp disk and a rebuild disk. The information handling system also includes a RAID controller in communication with the host and the plurality of storage disks. The RAID controller includes a rebuild management module able to initiate a rebuild operation on the rebuild disk utilizing a substantially sequential rebuild operation on the rebuild disk, receive at least one host I/O request from the host, and direct the at least one host I/O request to the temp disk.

The present disclosure includes a number of important technical advantages. One technical advantage is providing a rebuild management module utilizing a substantially sequential rebuild operation. This preferably decreases disk head thrashing during rebuild, thereby reducing overall rebuild time. Additional advantages will be apparent to those of skill in the art and from the figures, description and claims provided herein.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 is a diagram of an information handling system according to teachings of the present disclosure;

FIG. 2 is a flow diagram showing a method according to teachings of the present disclosure;

FIG. 3 is a flow diagram showing a method according to teachings of the present disclosure; and

FIG. 4 is another flow diagram showing a method according to teachings of the present disclosure.

### DETAILED DESCRIPTION OF THE INVENTION

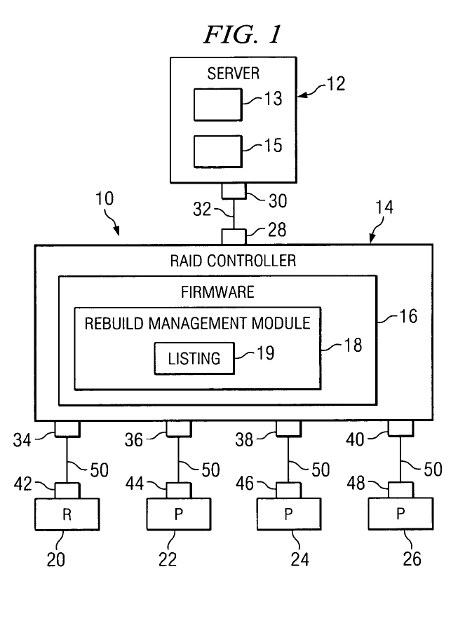

Preferred embodiments of the invention and its advantages are best understood by reference to FIGS. 1-4 wherein like numbers refer to like and corresponding parts and like element names to like and corresponding elements.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Now referring to FIG. 1, information handling system, referred to generally at 10, includes a server 12 (which may also be referred to as a “host” herein), RAID controller 14 and multiple storage resources 20, 22, 24 and 26 (which may be referred to herein as storage disks or storage drives). Storage resources 20, 22, 24 and 26 may comprise SCSI drives, SATA drives or any other suitable storage resource. Server 12 includes processor 13 and memory 15. Server 12 is operable to run one or more applications for processing, compiling, storing or communicating data or information. Server 12 also includes port 30 for operably connecting with RAID controller 14 via host port 28 and connection 32.

RAID controller 14 includes storage ports 34, 36, 38 and 40 for connecting with storage disks 20, 22, 24 and 26. More specifically, storage disk 20 includes port 42 in communication with storage port 34 via connection 50. Storage disk 22 includes port 44 for connecting with storage port 36 via connection 50. Storage resource 24 includes port 46 for connecting with storage port 38 via connection 50. Also, storage disk 26 includes port 48 for connecting with storage port 40 via connection 50. Connections 32 and 50 may comprise peripheral component interconnect (PCI), peripheral component interconnect express (PCIe), Small Computer Systems Interface (SCSI), Fibre Channel, Serial-Attached SCSI (SAS), or any other connection for transmitting information to and from RAID controller 14.

In the present embodiment, storage disks 20, 22, 24 and 26 comprise three types of disks. The first type of disks is the source disks, which are the “healthy” disks within a degraded RAID from which data for the rebuild disk will be calculated. In the present exemplary embodiment, disks 22 and 24 are source disks. The second type of disks included in the present embodiment is the rebuild disk which is a storage resource (or a port of a storage resource) that has failed and been replaced with a hot spare or replacement disk to which rebuild data is written. In the present exemplary embodiment, storage disk 20 is a rebuild disk. The third type of disk included in the present exemplary embodiment is a temp disk which is an unused disk, a hot spare disk or part of a disk which is not being used within the RAID that can be used to enhance the rebuild operation according to the teachings herein. In larger storage systems, multiple hot spare disks often exist and one of these disks can be used. In the present exemplary embodiment, disk 26 is a temp disk.

The present embodiment shows four separate storage disks 20, 22, 24 and 26. In alternate embodiments the present disclosure contemplates the use of more or fewer storage disks as well as including multiple disks within each storage resource. For instance, storage disk 20 may actually include multiple physical storage disks within each storage resource 20.

Redundant array of inexpensive disks (RAID) controller 14 includes firmware 16. Firmware 16 includes executable instructions for performing the functions described below. Firmware 16 may also comprise an associated memory (not expressly shown) for storing such executable instructions. Firmware 16 further includes rebuild management module 18. In the present embodiment rebuild management module 18 includes listing 19.

As described below, rebuild management module 18 acts to manage a rebuild operation for one of the associated storage disks 20, 22, 24 or 26. Rebuild management module 18 acts to ensure that the rebuild operations of a storage disk that needs to be rebuilt is performed in a substantially sequential fashion and that host I/O requests received from the server or host 12 are completed using a disk other than the rebuild disk and storing the logical block address (LBA) of the rebuild disk associated with the host I/O in listing 19. After a rebuild operation is complete, rebuild management module 18 then uses listing 19 to update the rebuild disk to reflect any changes that have occurred based on host I/O requests received during the rebuild operation and completed using another storage disk.

In this manner, rebuild management module 18, acts to resolve the problem of disk head thrashing by using a two pass rebuild process. In the first pass, the disk is rebuilt sequentially from the beginning (first logical block address) to the end (maximum logical block address). In the second pass, the disk is updated with the incremental changes that occurred during the first pass.

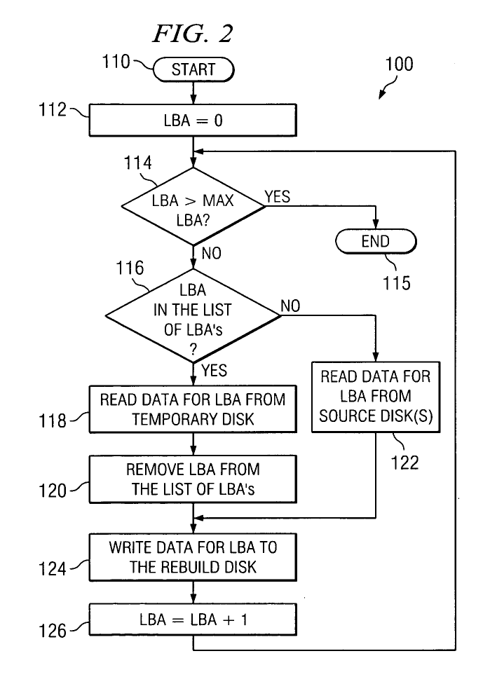

Now referring to FIG. 2, a flow diagram generally referred to at 100 shows a method according to teachings of the present disclosure for rebuilding a rebuild disk. The method described herein occurs after a disk has failed and has been replaced with either a hot spare disk or a replacement disk. The method begins at 112 with the rebuild management module 18 beginning the rebuild at logical block address (LBA) zero. Next, rebuild management module 18 determines whether the current LBA is greater than the maximum LBA of the rebuild disk 114. If the current LBA is greater than the max LBA, method ends at 115. However, if the current LBA is not greater than the max LBA, rebuild management module 18 proceeds to determine if the next LBA is within listing 19 of LBAs at 116.

If the LBA is not within the list of LBAs, then the data is read for the current LBA from source disks 122 and the method proceeds directly to step 124. In the exemplary environment of FIG. 1, this data would be read from source disks 22 and 24. If the LBA is within the list of LBAs, then the data is read for the current LBA from temporary disk at 118. In the exemplary embodiment of FIG. 1, this data would be read from temp disk 26. The current LBA would then be removed from listing 19 of LBAs at 120. Next, the data that has just been read is then written to the LBA on the rebuild disk at 124. In the present embodiment this data would be written to rebuild disk 20. Next, rebuild management module 18 increases the current LBA by one at 126. In this manner, rebuild management module 18 selects the next sequential LBA to be rebuilt.

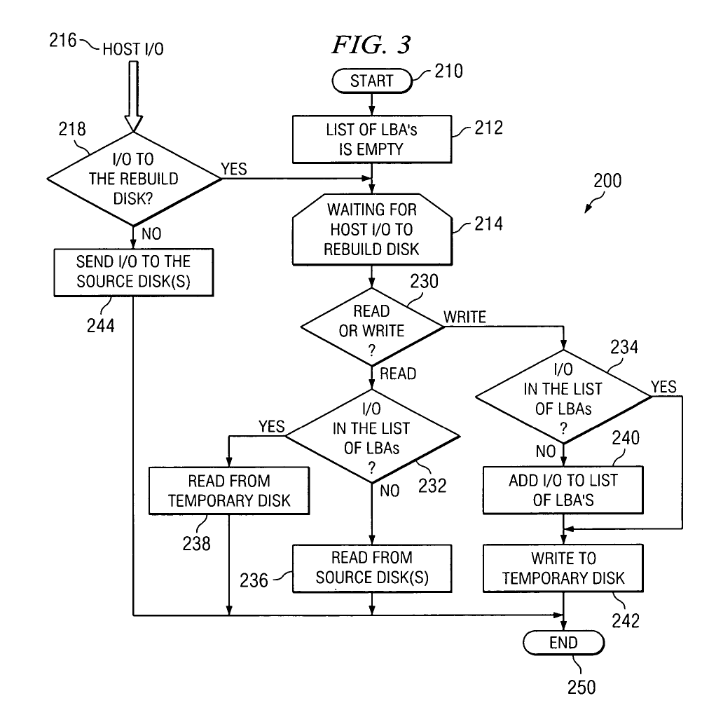

Now referring to FIG. 3, a method generally indicated at 200 for managing host I/O requests during the rebuild operation is shown. The method begins at 210 with the listing 19 of LBAs being empty at 212. A host I/O request at 216 is then sent from host 12 to RAID controller 14 and it is determined whether the host I/O request requires access to the rebuild disk at 218. If the rebuild disk is not required to complete the host I/O, the RAID controller sends the host I/O request to the appropriate source disk at 244. However, if the host I/O request requires access to the rebuild disk (in the embodiment in FIG. 1, for instance if the host I/O requests requires information to be read from or written to rebuild disk 20) the method moves to step 214 wherein the rebuild management module 18 is awaiting host I/O requests to the rebuild disk.

It is then determined whether the host I/O request is a read or write request at 230. If the host I/O request is a read request it is then determined whether the host I/O request is within the listing 19 of LBAs at 232. If the host I/O request is within the listing 19, the host I/O request is read from the temporary disk at 238. If the read request is not within the listing 19 of LBAs, the read request is read from an appropriate source disks at 236.

In the event that the host I/O request is a write request, it is first determined whether the write request is within listing 19 of LBAs at 234. If the write request is not within the listing 19, it is added to the listing of LBAs at 240. If the write request is within listing 19, the method moves directly to step 242. In step 242, the write request proceeds with writing to the temp disk. In the exemplary embodiment of FIG. 1, the write request would proceed to writing to temp disk 26. The method then ends at 250.

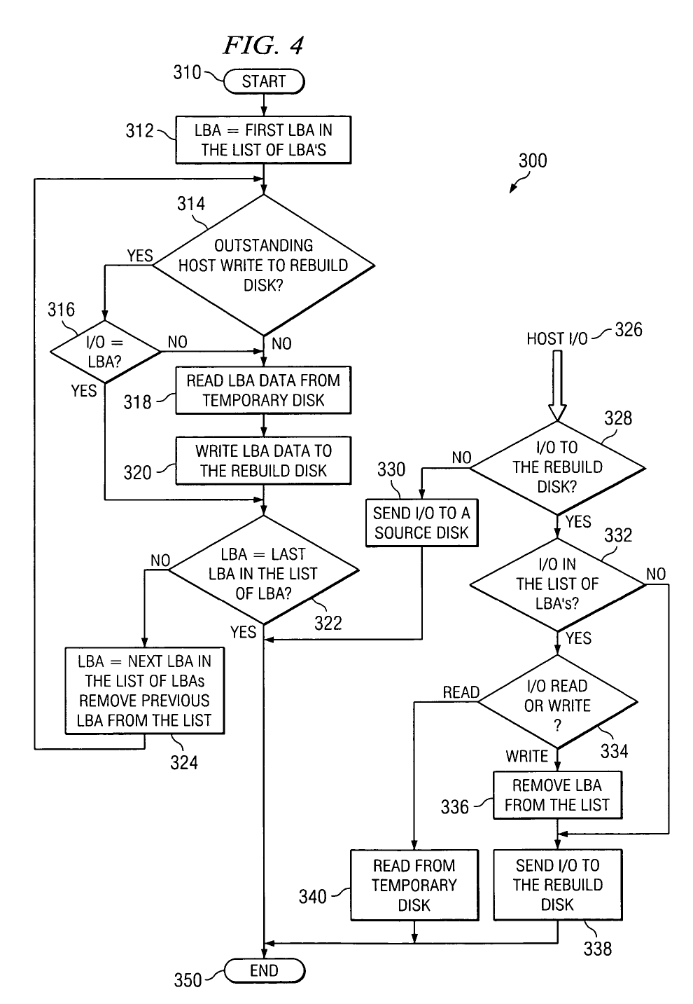

During the processing of host I/O requests shown above, the disk head of the rebuild disk is not being thrashed and will thereby allow the sequential rebuild to proceed without interruption. As shown in FIG. 4, below after the sequential rebuild or “first pass” is complete, changes related to host I/O received and processed during rebuild may then be updated on the rebuild disk.

Now referring to FIG. 4, a method indicating generally at 300 is shown for updating a rebuild disk to reflect host I/O requests received and processed during a rebuild operation. Method begins at 310 with the current LBA equal to the first LBA within listing 19 of LBAs at 312. Next it is determined whether there is an outstanding host write request to the rebuild disk at 314. If yes, it is determined whether or not the outstanding I/O request is equal to the current LBA at 316. If yes, then the method proceeds to step 322. If not, the method proceeds to step 318.

If it is determined that there is not an outstanding host write request to rebuild disk, the LBA data is read from temporary disk at 318. Next, the method proceeds to write LBA data to the rebuild disk at 320. The method then proceeds to step 322 where it is determined whether the current LBA is equal to the last LBA in listing 19. If not, the LBA is increased to the next LBA within the listing, and the previous LBA (that was just written) is removed from the list at 324. The method then proceeds to step 314. However, if the LBA is equal to the last LBA on the list, the method then proceeds to step 350.

During this process, an additional host I/O request at 326 may be received. It is then determined whether the host I/O request involves the rebuild disk at 328. If the host I/O request is not directed to the rebuild disk, the host I/O request is then sent to an appropriate source disk at 330. If the host I/O request is being sent to the rebuild disk, however, it is then determined whether the host I/O request is within listing 19 of LBAs at 332. If the host I/O request is not within the listing of LBAs, the method proceeds to step 338. If the host I/O request is within the listing of LBAs, the method proceeds to step 334 in which a determination is made as to whether the request is a read request or write request 334. In the event that the request is a write request, the method moves to step 336 where the LBA of the write request is removed from the list 336. Next, the I/O request is sent to the rebuild disk at 338. If the I/O request is a read request, the method proceeds to read from the temporary disk at 340. The method then proceeds to step 350. After the method is complete at 350, the temp disk can be released and reassigned to another function.

Although the disclosed embodiments have been described in detail, it should be understood that various changes, substitutions and alterations can be made to the embodiments without departing from their spirit and scope.

What is claimed is:

1. An information handling system comprising:
a redundant array of independent disks (RAID) controller operable to communicate with a host and a plurality of storage disks;
the RAID controller further comprising a rebuild management module operable to:
initiate a rebuild operation on a rebuild disk utilizing a substantially sequential rebuild operation;
receive at least one host I/O request from the host; and
direct the at least one host I/O request to a disk within the plurality of storage disks other than the rebuild disk.

2. The information handling system of claim 1 wherein the disk other than the rebuild disk comprises a temp disk and the rebuild management module operable to, after completion of the substantially sequential rebuild operation, update the rebuild disk to reflect the host I/O requests directed to the temp disk.

3. The information handling system of claim 1 further comprising the rebuild management module operable to:
develop a listing of the logical block addresses (LBAs) required to rebuild the rebuild disk;
select the first LBA to rebuild;
obtain rebuild data for the selected LBA from a source disk;
remove the selected LBA from the listing;
write the rebuild data to the selected LBA on the rebuild disk; and
select the next sequential LBA to rebuild.

4. The information handling system of claim 1 further comprising the rebuild management module operable to determine that the selected LBA is the maximum LBA in the listing and determine the rebuild to be complete.

5. The information handling system of claim 1 wherein the host comprises a server having processor and memory and operable to run a plurality with applications.

6. The information handling system of claim 4 further comprising the server and the RAID controller connected by a Peripheral Component Interconnect (PCI) connection.

7. The information handling system of claim 4 further comprising the server and the RAID controller connected by a Peripheral Component Interconnect Express (PCIe) connection.

8. The information handling system of claim 1 further comprising the rebuild management module incorporated within firmware of the RAID controller.

9. The information handling system of claim 1 wherein the plurality of storage disks comprises:
at least one temp disk;
at least one source disk; and
the rebuild disk.

10. A method comprising:
providing a redundant array of independent disks (RAID) controller operable to communicate with a host and a plurality of storage disks;
initiating a rebuild operation on a rebuild disk utilizing a substantially sequential rebuild operation on the rebuild disk;
receiving at least one host I/O request from the host; and
directing the at least one host I/O request to a temp disk within the plurality of storage disks.

11. The method of claim 10 further comprising providing a rebuild management module within the RAID controller for managing the rebuild process and the host I/O request.

12. The method of claim 10 further comprising, after completion of the substantially sequential rebuild operation, updating the rebuild disk to reflect any host I/O requests directed to the temp disk.

13. The method of claim 10 further comprising:
developing a listing of the logical block addresses (LBAs) to rebuild on the rebuild disk;
selecting the first LBA to rebuild;
obtaining rebuild data for the selected LBA from a source disk;
removing the selected LBA from the listing;
writing the rebuild data to the selected LBA on the rebuild disk; and
selecting the next sequential LBA to rebuild.

14. The method of claim 10 further comprising:
developing a listing of the logical block addresses (LBAs) to rebuild on the rebuild disk;
selecting the first LBA to rebuild;
obtaining rebuild data for the selected LBA from a source disk;
removing the selected LBA from the listing;
writing the rebuild data to the selected LBA on the rebuild disk;
selecting the next sequential LBA from the listing to rebuild and repeating the rebuild steps for the selected next sequential LBA;
determining that the last sequential LBA has been rebuilt; and
updating the rebuild disk to reflect any host I/O requests directed to the temp disk during the rebuild of the rebuild disk.

15. An information handling system comprising:
A host;
a plurality of storage disks comprising at least one source disk, at least one temp disk and a rebuild disk;
a redundant array of independent disks (RAID) controller in communication with the host and the plurality of storage disks;
the RAID controller further comprising a rebuild management module operable to:
initiate a rebuild operation on the rebuild disk utilizing a substantially sequential rebuild operation on the rebuild disk;
receive at least one host I/O request from the host; and
direct the at least one host I/O request to the temp disk.

16. The information handling system of claim 15 further comprising the rebuild management module operable to, after completion of the substantially sequential rebuild operation, updating the rebuild disk to reflect the host I/O requests directed to the temp disk.

17. The information handling system of claim 15 further comprising the rebuild management module operable to:
develop a listing of the logical block addresses (LBAs) to rebuild on the rebuild disk;
select the first LBA to rebuild;
obtain rebuild data for the selected LBA from a source disk;
remove the selected LBA from the listing;
write the rebuild data to the selected LBA on the rebuild disk; and
select the next sequential LBA to rebuild.

18. The information handling system of claim 15 wherein the host comprises a server having a processor and memory and operable to run a plurality with applications.

19. The information handling system of claim 15 further comprising the rebuild management module operable to:
develop a listing of the logical block addresses (LBAs) to rebuild on the rebuild disk;
select the first LBA to rebuild;
obtain rebuild data from a source disk for the selected LBA;
remove the selected LBA from the listing;
write the rebuild data to the selected LBA on the rebuild disk; and
select the next sequential LBA to rebuild.

20. The information handling system of claim 15 further comprising the rebuild management module incorporated within firmware of the RAID controller.
